(19) United States
(12) Patent Application Publication
(10) Pub. No.: US 2006/0218550 A1
(43) Pub. Date: Sep. 28, 2006

(54) Virtual machine for timing-critical tasks on microprocessors

(75) Inventor: Ping Tao, Richardson, TX (US)

Correspondence Address: TEXAS INSTRUMENTS INCORPORATED, P O BOX 655474, M/S 3999, DALLAS, TX, 75265, US

(73) Assignee: Texas Instruments Inc., Dallas, TX (US)

(21) Appl. No.: 11/387,577

(22) Filed: Mar. 23, 2006

Related U.S. Application Data
(60) Provisional application No. 60/664,604, filed on Mar. 23, 2005.

(51) Int. Cl. G06F 9/455

(52) U.S. Cl. 718/1

(57) ABSTRACT

The present invention provides a virtual machine for use with a general purpose processor (GPP). In one embodiment, the virtual machine includes a register set of the GPP dedicated to retain an execution context corresponding to an interrupt-driven task. The virtual machine also includes an interrupt generator coupled to the register set and configured to provide at least one interrupt event associated with the interrupt-driven task. The virtual machine further includes a virtual processor coupled to the interrupt generator and configured to execute a processing state corresponding to each interrupt event.

### CROSS-REFERENCE TO PROVISIONAL APPLICATION

This application claims the benefit of U.S. Provisional Application No. 60/664604 entitled “Software Virtue Machine on Microprocessors for Hard Real-Time Tasks” to Ping Tao, filed on Mar. 23, 2005, which is incorporated herein by reference in its entirety.

### TECHNICAL FIELD OF THE INVENTION

The present invention is directed, in general, to signal processing, and more specifically, to a virtual machine, a method of providing a virtual machine and a general purpose processor employing the virtual machine or the method.

### BACKGROUND OF THE INVENTION

The demand for enhanced system performance along with reduced integrated circuit size capabilities has allowed for the development of a complete working product on a single integrated circuit chip. This system-on-chip (SoC) capability can be distinguished from traditional integrated devices by the marked increase in system complexity as well as the integration of several technology domains.

SoC applications typically use a general purpose processor (GPP) such as an ARM processor or a MIPS processor. The purpose of the SoC is often that of a controller, which is required to handle deterministic functions or tasks that are interrupt-driven at a very low latency. Low latency means a task that can be accomplished in 20 to 100 clock cycles. Deterministic means that the number of clock cycles required to accomplish these tasks does not vary greatly from function to function or time to time. That is, the task should not require 20 clock cycles one time and 80 clock cycles the next time.

In most SoC designs, the GPP is used to handle multiple real-time tasks. However, some tasks are so critical with regard to timing that special purpose hardware peripherals or microcontroller units (MCUs) are added to the system to implement the most timing-critical functions. These extra hardware blocks impose higher development and production costs as well as raise the programming effort required for the SoC product. This often increases the time-to-market for the product, which may be the most critical factor.

Accordingly, what is needed in the art is an enhanced way to implement timing-critical tasks or functions associated with a GPP that overcomes the limitations of the current art.

### SUMMARY OF THE INVENTION

To address the above-discussed deficiencies of the prior art, the present invention provides a virtual machine for use with a general purpose processor (GPP). In one embodiment, the virtual machine includes a register set of the GPP dedicated to retain an execution context corresponding to an interrupt-driven task. The virtual machine also includes an interrupt generator coupled to the register set and configured to provide at least one interrupt event associated with the interrupt-driven task. The virtual machine further includes a virtual processor coupled to the interrupt generator and configured to execute a processing state corresponding to each interrupt event.

In another aspect, the present invention provides a method of providing a virtual machine for use with a general purpose processor (GPP). The method includes retaining an execution context corresponding to an interrupt-driven task employing a dedicated register set of the GPP and providing at least one interrupt event associated with the interrupt-driven task employing an interrupt generator. The method also includes executing a processing state corresponding to each interrupt event employing a virtual processor.

The present invention also provides, in yet another aspect, a general purpose processor (GPP). The GPP includes a hardware portion; a hardware abstraction layer coupled to the hardware portion, a real time operating system (RTOS) coupled to the hardware abstraction layer and an application software layer coupled to the RTOS. The GPP also includes a virtual machine coupled to the hardware abstraction layer. The virtual machine has a register set of the hardware portion dedicated to retain an execution context corresponding to an interrupt-driven task. The virtual machine also has an interrupt generator, coupled to the register set, that provides at least one interrupt event associated with the interrupt-driven task. The virtual machine further has a virtual processor, coupled to the interrupt generator, that executes a processing state corresponding to each interrupt event.

### BRIEF DESCRIPTION OF THE DRAWINGS

For a more complete understanding of the present invention, reference is now made to the following descriptions taken in conjunction with the accompanying drawings, in which:

FIG. 1 illustrates a general purpose processor (GPP) as provided by one embodiment of the invention;

FIG. 2 illustrates an embodiment of a state diagram associated with an Rx virtual machine such as was discussed with respect to FIG. 1; and

FIG. 3 illustrates a method of providing a virtual machine for use with a GPP.

### DETAILED DESCRIPTION

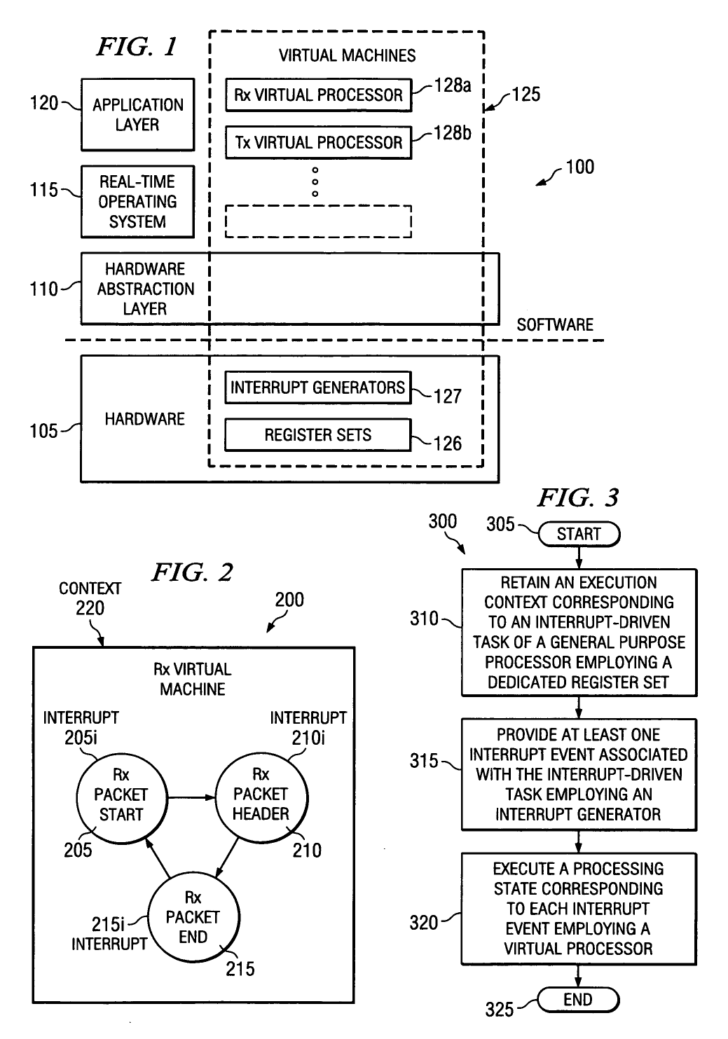

FIG. 1 illustrates a general purpose processor (GPP) 100 as provided by one embodiment of the invention. The illustrated GPP 100 includes processor hardware 105 and associated software having a hardware abstraction layer 110, a real-time operating system (RTOS) 115 and an application software layer 120. The GPP 100 also includes a plurality of virtual machines (VMs) 125. The GPP 100 is a portion of a system-on-chip (SoC) product that is employed in a wireless application having wireless transmissions and receptions, in this particular embodiment of the invention.

Each of the plurality of VMs 125 employs a register set and an interrupt generator included in a corresponding plurality of register sets 126 and interrupt generators 127, respectively. In the illustrated embodiment, each of these register sets and interrupt generators are a portion of the hardware 105 and correspond to virtual processors such as receive (Rx) and transmit (Tx) virtual processors 128a, 128b in the software, for example. Each of the register sets is dedicated to retaining an execution context corresponding to a particular interrupt-driven task in the GPP 100. Correspondingly, each of the interrupt generators is coupled to its corresponding register set and configured to provide at least one interrupt event associated with its interrupt-driven task. Accordingly, each of the virtual processors, such as the Rx and Tx virtual processors 128a, 128b, is coupled to its corresponding interrupt generator and configured to execute a processing state corresponding to each of its particular interrupt events.

In the illustrated embodiment, an ARM9 processor is employed for the GPP 100 and provides the processor hardware 105, although another similar current or future-developed processor may be used. The hardware abstraction layer 110 allows some abstraction of the software from the hardware so that the software may be somewhat independent of the actual hardware employed. This would allow an API function call that any software could use to trigger a particular hardware function. For example, in the present embodiment, there could be a function call “ENABLE Rx” that would “turn on” the receive function and translate this into the appropriate particular register in the hardware.

The RTOS 115 is a layer in the software, which may be LINEX for example, that generally operates the hardware in real time. The application software layer 120 may include an IP stack or software for a wireless LAN protocol, for example. A virtual processor, such as the Rx virtual processor 128a, operates independently from the other software layers and communicates only with the hardware 105 through the hardware abstraction layer 110, in the illustrated embodiment.

The plurality of software VMs 125 constitutes a virtual machine environment for timing-critical tasks. The plurality of software VMs 125 allows at least a portion of the timing-critical tasks or functions associated with the GPP 100 to be performed employing compatible software that runs on the existing processor hardware 105. Software-based virtual processors may be added to the software architecture that employ the main central processing unit (CPU) to enable it to handle these timing-critical functions more efficiently. This generally reduces the need for MCUs along with their extraneous programming and interfacing requirements.

The virtual machine environment allows the execution of these special tasks to be isolated from the normal execution flow in the GPP 100. Many current general purpose processors, such as the ARM9 and MIPS M4K processors, provide additional or “shadow” registers for faster interrupt context switching. Embodiments of the present invention employ at least a portion of the register sets 126 to setup a dedicated execution context for hard, real-time tasks. Then, the interrupt generators 127 coupled to these register sets provide hardware interrupts to get into and out of these dedicated execution contexts, in the illustrated embodiment. Other embodiments may employ software interrupts for this activity. Implementations of the virtual machine environment may thereby employ purely software-based additions for current RISC processors.

This dedicated virtual machine environment for hard, real-time tasks does not employ services from the RTOS 115. Other tasks and the RTOS 115 still run in the regular context of the GPP 100 and do not need to be aware of the existence of the hard, real-time tasks accommodated by the virtual machine environment. This approach ensures a short and deterministic response time for these time-critical tasks and alleviates the need for the RTOS 115 to accommodate these interrupt-driven events by employing general purpose register sets, which are used for other computing tasks. Additionally, use of the dedicated virtual machine environment effectively allows for internal accommodation of these interrupt-driven events as compared to the current use of external MCUs coupled to the GPP 100 via a general purpose interface bus.

FIG. 2 illustrates an embodiment of a state diagram 200 associated with an Rx virtual machine such as was discussed with respect to FIG. 1. The state diagram 200 includes first, second and third processing states 205, 210, 215, which operate in a context 220 and are triggered or driven by first, second and third interrupt events 205i, 210i. 215i, respectively. The state diagram 200 is representative of a virtual machine environment corresponding to an interrupt service routine that provides a very low context switching overhead since the context values are associated with dedicated register sets.

In the illustrated embodiment, the three interrupt events are associated with a receive (Rx) packet, which includes an Rx packet start, an Rx packet header and an Rx packet end. These three events all trigger the same vector. For this Rx virtual machine, the first state 205 represents the Rx packet start, the second state 210 represents the Rx packet header and the third state 215 represents the Rx packet end, as shown.

There is commonly shared, relevant information among the three interrupts 205i, 210i, 215i and this information relates to the Rx packet, in this example. Some of this information that is used in the Rx packet start is reused in parsing of the Rx packet header and Rx packet end. This shared and relevant information is employed to direct Rx packets into memory locations or a particular queue and is in the context 220, which basically represents the Rx virtual machine as a dedicated venture. Although these are different interrupts, they are all relevant to the same Rx virtual machine. This allows running of the software as though it is being done on a dedicated CPU although only one vector is being employed. The dedicated set of registers, which are employed in a general purpose way as far as the Rx virtual machine is concerned, is key to accommodating the timing-critical tasks.

An example of a vector that may be used, for example, is dedicating interrupt 3 as the Rx virtual machine from a possibility of up to 32 different interrupt numbers (0, 1, 2, 3, 4, etc). Then, the register context number vector 3 employs its own dedicated registers, meaning that it is not visible from other GPP modes. Software for the GPP employed is able to set up the relevant context values. For example, parameters like header value or user station ID may be relevant information for Rx and therefore stored. Therefore, when the Rx packet actually arrives, the user station ID may be compared against the value in the incoming Rx header. Then, an interrupt 3 set up this way would be known to relate to Rx.

In the illustrated embodiment of FIG. 2, the first interrupt 205i is designed to indicate an Rx packet start. Then the Rx packet header and the Rx packet end occur at the second and third interrupts 210i, 215i wherein all three of these are connected to the same vector. This arrangement allows the system to stop and finish state 205 corresponding to the first interrupt 205i and then return to other tasks. When the second interrupt 210i occurs, the process continues in the second state 210 since the context is already in the dedicated register. This interrupt-instigated action continues until all states (three in this example) are complete.

FIG. 3 illustrates a method 300 of providing a virtual machine for use with a general purpose processor (GPP). The method 300 starts in a step 305, and an execution context is retained corresponding to an interrupt-driven task employing a dedicated register set of the GPP in a step 310. The execution context corresponds to an interrupt vector, and in one embodiment, the interrupt-driven task corresponds to a receive signal or a transmit signal.

Then, in a step 315, at least one interrupt event associated with the interrupt-driven task is provided employing an interrupt generator. The interrupt event may be provided from a hardware or software source. A processing state corresponding to each interrupt event is executed, in a step 320, employing a virtual processor. Execution of the processing state in the step 320 is performed independently of a normal execution flow in the GPP. Additionally, execution of the processing state is performed in a deterministic response time employing a common central processing unit (CPU). The method 300 ends in a step 325.

In summary, embodiments of the present invention of a GPP employing virtual machines for timing-critical tasks and a method of providing a virtual machine have been presented. Advantages include being able to provide a virtual machine environment employing additional software, conventional to the GPP, that uses existing hardware and incurs no additional silicon costs or additional power consumption. The virtual machine environment can be implemented on a variety of current processors and employs the same ISA for the timing-critical functions. Additionally, advantage may be taken of high level programming languages (such as C or C++, for example) as well as development tools available for higher productivity. This approach provides better utilization of the microprocessors, especially in SoC designs.

Those skilled in the art to which the invention relates will appreciate that other and further additions, deletions, substitutions and modifications may be made to the described embodiments without departing from the scope of the invention.

What is claimed is:

1. A virtual machine for use with a general purpose processor (GPP), comprising:
a register set of said GPP dedicated to retain an execution context corresponding to an interrupt-driven task;
an interrupt generator coupled to said register set and configured to provide at least one interrupt event associated with said interrupt-driven task; and
a virtual processor coupled to said interrupt generator and configured to execute a processing state corresponding to each interrupt event.

2. The virtual machine as recited in claim 1 wherein each interrupt event is provided from a hardware or software source.

3. The virtual machine as recited in claim 1 wherein said interrupt-driven task corresponds to a receive signal or a transmit signal.

4. The virtual machine as recited in claim 1 wherein execution of said processing state is performed independently of a normal execution flow in said GPP.

5. The virtual machine as recited in claim 1 wherein execution of said processing state is performed in a deterministic response time.

6. The virtual machine as recited in claim 1 wherein said execution context corresponds to an interrupt vector.

7. The virtual machine as recited in claim 1 wherein executing said processing state employs a common central processing unit (CPU).

8. A method of providing a virtual machine for use with a general purpose processor (GPP), comprising:
retaining an execution context corresponding to an interrupt-driven task employing a dedicated register set of said GPP;
providing at least one interrupt event associated with said interrupt-driven task employing an interrupt generator; and
executing a processing state corresponding to each interrupt event employing a virtual processor.

9. The method as recited in claim 8 wherein each interrupt event is provided from a hardware or software source.

10. The method as recited in claim 8 wherein said interrupt-driven task corresponds to a receive signal or a transmit signal.

11. The method as recited in claim 8 wherein execution of said processing state is performed independently of a normal execution flow in said GPP.

12. The method as recited in claim 8 wherein execution of said processing state is performed in a deterministic response time.

13. The method as recited in claim 8 wherein said execution context corresponds to an interrupt vector.

14. The method as recited in claim 8 wherein executing said processing state employs a common central processing unit (CPU).

15. A general purpose processor (GPP), comprising:
a hardware portion;
a hardware abstraction layer coupled to said hardware portion;
a real time operating system (RTOS) coupled to said hardware abstraction layer;
an application software layer coupled to said RTOS; and
a virtual machine coupled to said hardware abstraction layer, including:
a register set of said hardware portion dedicated to retain an execution context corresponding to an interrupt-driven task,
an interrupt generator, coupled to said register set, that provides at least one interrupt event associated with said interrupt-driven task; and
a virtual processor, coupled to said interrupt generator, that executes a processing state corresponding to each interrupt event.

16. The GPP as recited in claim 15 wherein each interrupt event is provided from a hardware or software source.

17. The GPP as recited in claim 15 wherein said interrupt-driven task corresponds to a receive signal or a transmit signal.

18. The GPP as recited in claim 15 wherein execution of said processing state is performed independently of a normal execution flow in said GPP.

19. The GPP as recited in claim 15 wherein execution of said processing state is performed in a deterministic response time.

20. The GPP as recited in claim 15 wherein said execution context corresponds to an interrupt vector.

21. The GPP as recited in claim 15 wherein executing said processing state employs a common central processing unit (CPU).
